(19) United States
(12) Patent Application Publication
(10) Pub. No.: US 2014/0143615 A1
(43) Pub. Date: May 22, 2014

(54) EMBEDDED APPARATUS, PROGRAM GENERATION APPARATUS, AND PROGRAM

(71) Applicant: Toshikazu Ohwada, Chiba (JP)

(72) Inventor: Toshikazu Ohwada, Chiba (JP)

(21) Appl. No.: 14/130,137

(22) PCT Filed: Jul. 4, 2012
(86) PCT No.: PCT/JP12/67631

§ 371 Date: Dec. 30, 2013

(30) Foreign Application Priority Data
Jul. 15, 2011 (JP) 2011-157183
May 15, 2012 (JP) 2012-111680

(51) Int. Cl. G06F 11/07; G06F 17/30

(52) U.S. Cl. CPC G06F 11/0769; G06F 17/30129
USPC 714/57; 707/695

(57) ABSTRACT

An embedded apparatus displaying an error message upon detection of a failure during execution of a program includes a central processing unit executing the program; a program storage unit storing an executable compressed file where plural files are combined as the program; a failure detection unit detecting a failure based on storage contents of addresses storing execution results of instructions; and an error message display unit outputting the error message on a display device when the failure detection unit detects the failure, the error message including version information of the program, file identification information of the file, and line numbers of the instruction being executed in the file, the error message being described in the instruction.

### TECHNICAL FIELD

The present invention relates to an embedded apparatus displaying an error message upon detection of a failure during execution of a program.

### BACKGROUND ART

When an apparatus including a computer executes a program, upon an occurrence of an error, an error message may be displayed. Such a display of the error message may be useful to report not only the occurrence of the error but also a cause of the error to a user.

FIG. 1 illustrates an example of a conventional error message. Description 1 indicates a message reporting occurrence of an error to a user. Description 2 indicates a typical response to the occurrence of the error. Description 3 indicates a message including significance of reporting a cause of the error to the user. It depends on software how the Description 3 is displayed. However, generally, the maximum information amount to be displayed may be limited. Due to the limit, Description 3 is displayed using coded data (code) so that the user may recognize a cause of the error corresponding to the code by referring to a manual and the like. Also, the user may report the code to a support center, so that the support center may report a cause of the error to the user.

However, such a process of analyzing a cause of an error may bother a user. Therefore, there has been known a technique in which codes and corresponding error contents are stored in the apparatus where a program is executed (see, for example, Patent Document 1). Patent Document 1 discloses a diagnosis apparatus storing a table indicating relationships between events and corresponding failure parts. By storing the table in the apparatus, when a user wishes to specify a cause of the error, the necessity (frequency) of seeing an analysis manual or calling the support center may be reduced.
[Patent Document 1] Japanese Laid-Open Patent Application No. 2006-201927

### DISCLOSURE OF THE INVENTION

### Problems to be Solved by the Invention

However, the codes to be displayed upon occurrence of an error may roughly specify a cause of the error or where the error occurs, but may not accurately specify (pinpoint) where the error occurs in the source file. Namely, in related art, the same code may be displayed in a case where errors are similar to each other but the causes of the errors are different from each other. Therefore, the code alone may not provide information uniquely specifying what kind of an error actually occurs. This may also apply to the case where the table is stored in an apparatus as described in Patent Document 1. Namely, when an information amount of the codes is limited, it may be difficult to accurately specify (pinpoint) where an error occurs.

For example, by using an Integrated Development Environment (IDE) in developing a program, it may become possible to display a line number of the place where an error occurs in the program due to the IDE. Further, the line number where a grammatical error is included may be displayed during the compile process. However, it may be difficult to directly embed the IDE into an apparatus due to decreasing execution speed and limited resources.

Further, since line numbers may not be located in a program after the program is compiled, it is difficult to specify the line number of the program which is running when error occurs, the program being executed by the apparatus. This may also be applied to an interpreter language. Namely, even when the line numbers are located in the source code by the IDE in editing, the interpreter language does not typically include the line numbers in the program when the program is executed.

Further, to accurately specify (pinpoint) the place (part) where an error occurs, for example, it may be considered to use an error log so that the user or the support center may analyze a cause of the error. Error logs may include, for example, an error occurrence state and displayed error messages. Most programs generate the error log. Therefore, at least, by using the error log, it may become easier to specify a cause of an error than using an error message.

However, the error log may be too complicated for a user to analyze. Therefore, in many cases, it is difficult for a user to specify a cause of an error with the error log. Further, unlike a case of a general-purpose computer, in a case of an embedded apparatus, it is basically difficult for a user to access the error log.

It may be technically possible to cause the apparatus to transmit the error log to the support center, so that the support center may analyze the error log. However, many users may be reluctant to transmit the error logs which may include detailed information. Further, it may not always be desirable to show the error logs to the user because the error logs may allow a user to analyze the apparatus in detail.

The present invention is made in light of the above problems, and may provide an embedded apparatus which specifies where an error occurs in software based on a code displayed when the error occurs.

### Means for Solving the Problems

According to an aspect of the present invention, an embedded apparatus displaying an error message upon detection of a failure during execution of a program includes a central processing unit executing the program; a program storage unit storing an executable compressed file where plural files are combined as the program; a failure detection unit detecting a failure based on storage contents of addresses storing execution results of instructions; and an error message display unit outputting the error message on a display device when the failure detection unit detects the failure, the error message including version information of the program, file identification information of the file, and line numbers of the instruction being executed in the file, the error message being described in the instruction.

### Effects of the Present Invention

It may become possible to provide and specify where an error occurs in software based on a code displayed when the error occurs.

### BRIEF DESCRIPTION OF THE DRAWINGS

FIG. 1 is a drawing showing an example of an error message of related art;

FIG. 2 is a drawing showing an example of an error message according to an embodiment;

FIG. 3 is a drawing showing an example flow to analyze a cause of an error when the error occurs in an apparatus executing a program;

FIG. 4 is a drawing showing an example of the apparatus;

FIG. 5 is a drawing showing an example of a hardware configuration of an image processing apparatus or a Multi-Functional Peripheral (MFP);

FIG. 6 is a drawing showing an example of a hardware configuration of a communication terminal;

FIG. 7 is a drawing showing an example of a schematic perspective view of a program generation apparatus;

FIG. 8 is an example block diagram of the program generation apparatus and a program execution apparatus;

FIG. 9 is a drawing showing an example of a file code table;

FIG. 10 is a drawing showing an example of versions of a program;

FIG. 11 is a drawing showing an example of version management tables generated by a build tool;

FIG. 12 is a drawing showing an example of an error code;

FIG. 13 is a drawing showing an example of descriptions of a source file;

FIG. 14 is a drawing showing an example of a source file after being converted into error codes;

FIG. 15 is a flowchart showing a process of generating the error codes by the program generation apparatus;

FIG. 16 is a flowchart showing a process of displaying an error message when the apparatus or the communication terminal executes the program;

FIG. 17 is a drawing showing an example of the error code (embodiment 2);

FIG. 18 is a drawing showing an example of descriptions of a source file (embodiment 2);

FIG. 19 is a drawing showing an example of an error-number table in which the first argument is associated with the error numbers;

FIG. 20 is a drawing showing an example of the source file after being converted into the error codes;

FIG. 21 is a flowchart showing an example of a generating process of the error codes by the program generation apparatus (embodiment 2);

FIG. 22 is a flowchart showing an example of displaying the error message when a program execution apparatus executes a program (embodiment 2);

FIG. 23 is a drawing showing an example of a configuration of an error report system; and

FIG. 24 is a flowchart showing an operation process of the program execution apparatus and a terminal for maintenance in the support center.

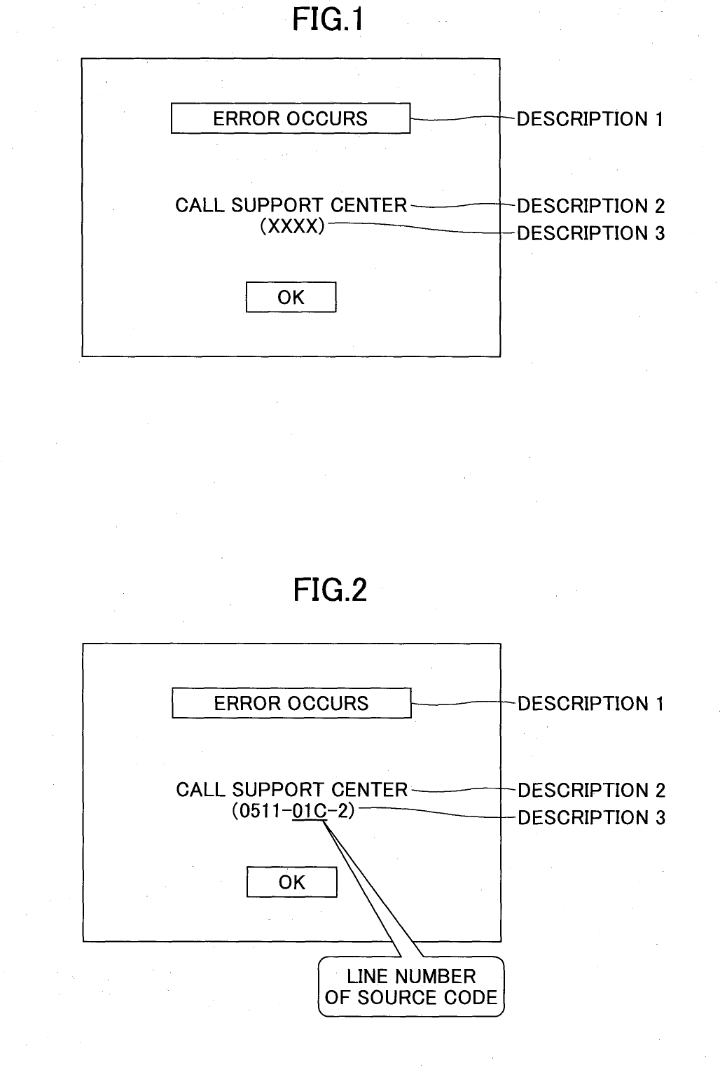

### DESCRIPTION OF THE REFERENCE NUMERALS

11: FILE CODE GENERATION SECTION
12: COMPILE SECTION
13: VERSION ACCEPT SECTION
14: CODE CONVERSION SECTION
15: LINKAGE SECTION
16: COMPRESSION SECTION
17: PROGRAM DL SECTION
18: ERROR DETECTION SECTION
19: ERROR MESSAGE DISPLAY SECTION
20: PROGRAM
31: ERROR NUMBER TABLE
100: INFORMATION PROCESSING APPARATUS
200: MFP
300: COMMUNICATION TERMINAL
301: COMMUNICATION SYSTEM
400: SERVER
500: PROGRAM GENERATION APPARATUS
600: TERMINAL FOR MAINTENANCE IN SUPPORT CENTER
700: ERROR REPORT SYSTEM

### BEST MODE FOR CARRYING OUT THE INVENTION

In the following, embodiments of the present invention are described.

### Embodiment 1

### Outline

First, an error message to be displayed on a program execution apparatus according to this embodiment is described.

FIG. 2 illustrates an example of the error message according to this embodiment. The error message of FIG. 2 includes the following three descriptions and an OK button.

Description 1: “Error occurs”
Description 2: “Call support center”

### Description 3: “0511-01C-0”

One of the features in the error message according to this embodiment is that a line number of a source file is included in Description 3. The data “01C” denotes the line number of the source file in hexadecimal. The data “05” denotes the version of the program. The data “11” denotes the name of the file where the error occurs. In the following, the entire Description 3 may be referred to as an error code.

Namely, in most cases, no line numbers are included in the instructions executed by a computer when an error occurs, but the information (data) indicating which line number corresponds to the instruction in the source file will be included in Description 3. Therefore, by reporting the contents of Description 3 to the support center and the like by a user, the support center and the like may accurately specify (pinpoint) the instruction where the error occurred, which may analyze a cause of the error promptly.

In FIG. 2. a case is described where the error code is included in the error message. However, for example, the error code may be separately displayed (i.e., displayed before or after the error message is displayed). Further, the version of the program, the file name, and the line number may be separately displayed.

Further, herein, the term “error” refers to a failure that may be detected by a program (i.e., an expectable failure). It is to be noted that term “error” does not refer to (include) an unexpected failure such as to prevent the display of the error message (e.g., a bug which may cause hang-up of the program, and a failure of hardware which may make it difficult to execute the program).

### Example Measures Upon Occurrence of an Error

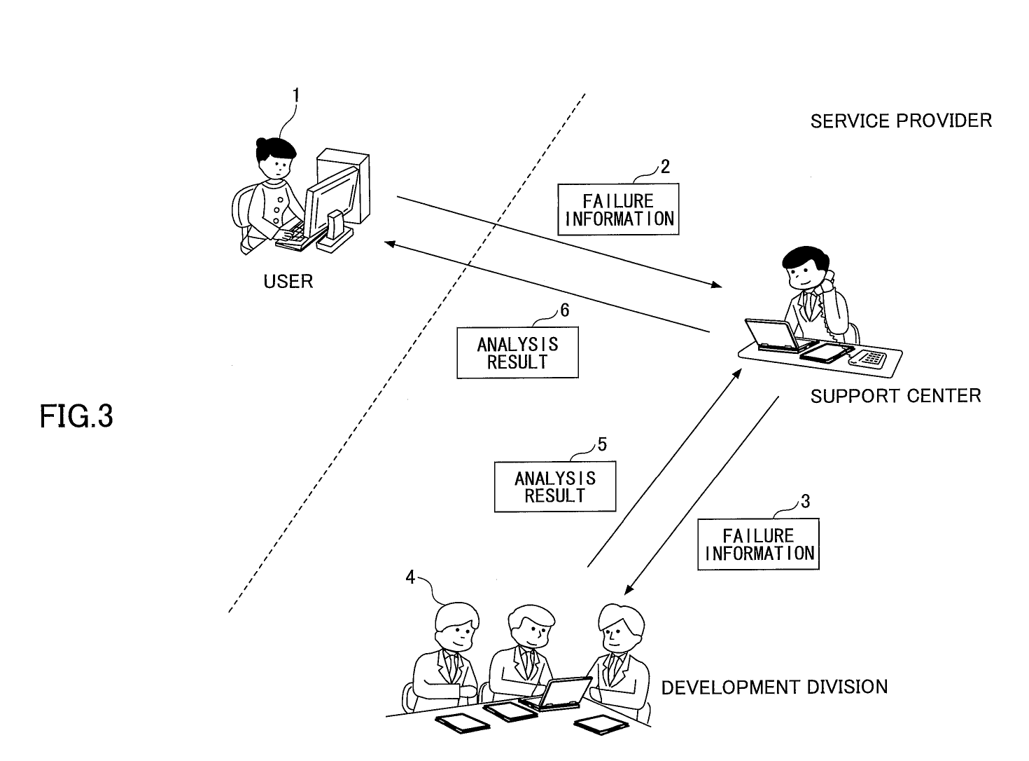

FIG. 3 illustrates an example flow when an error occurs in a program execution apparatus until a cause of the error is analyzed.

1. An error occurs, and the program execution apparatus displays an error message. Then, a user knows that the error occurs.
2. The user specifies a cause of the error based on the error message. When the error is restored (removed), the user may continue to use the program execution apparatus.

On the other hand, when the user may not understand a cause of the error by checking the error message, the manual and the like, the user may report failure information (i.e., the error message, the version of the program, the error occurrence state, the error logs and the like) to the support center of the provider of the program execution apparatus. The report may be made by using a telephone or e-mail. The user may report the failure information in any case other than a case where the error may not be restored. This is because many program execution apparatuses may be restored by rebooting.

3. The support center analyzes the cause of the error based on the reported failure information. In a case where the support center alone is unable to assist the user to restore the program execution apparatus nor specify the cause of the error, the failure information is further reported to the development division of the provider (manufacturer) of the program execution apparatus.
4. The development division analyzes the cause of the error based on the failure information and takes measures.
5. The development division reports the analysis result to the support center.
6. The support center reports the analysis result and possible measures when necessary to the user.

Here, in the analysis in the above (step) “4.”, the more information included in the failure information, the easier the analysis of the cause of the error by the development division becomes. However, for example, the failure information including all necessary information may not always be acquired. Namely, the difficulty of acquiring the failure information may vary depending on cases.

The failure information may include:

(i) the error (failure) occurrence state (e.g., what operation is being executed when the error occurs, what operations were performed before the error occurs, a hardware configuration and the like);
(ii) the error message displayed for the user;
(iii) the version of the program where the error occurs; and
(iv) the error logs.

For example, the data (i) may be acquired when the user carefully monitors (watches) the operating state of the program execution apparatus, but the acquired information may be limited if the user does not carefully monitor the operating state. The more detailed the information of the failure occurrence state is acquired, the more desirable it becomes. But, the more detailed the information is to be acquired, the more difficult the acquisition of the information becomes.

The data (ii) (i.e., the error message) may be displayed in many cases except when, for example, the program execution apparatus hangs up. Therefore, it may be easy for the user and the support center to acquire the error message. However, as described above, the error message may not include sufficient information for the user or the support center to analyze the cause of the error.

By acquiring the data (iii) (i.e., the version of the program), the development division may estimate the cause of the error relatively easily. This is because the cause of the error may be unique in a specific version and the report of the relationship between the error and the version may be reported already with higher likelihood. To acquire the version, the user may have to conduct a specific operation unless, for example, the version is automatically displayed while the program is started or after the program starts.

Further, once the version is acquired, the versions of the various files included in the program may be accordingly acquired. Therefore, it may become easier to analyze the cause of the error specific to the version of the program.

The data (iv) (i.e., the error logs) may include all the data (i) through (iv). The error logs may include information to specify the detailed case of the error and the place (part) in which the error occurs, specifically the information including the name of the file where the error occurs and the version of the program and being essential to perform the detailed analysis. Therefore, it is most desirable to acquire the error logs. But, the error logs contain the information that is most difficult to acquire. As described above, the reason for this is that the user is reluctant to externally provide such information. In addition, the provider of the apparatus is also reluctant to allow the users to easily (directly) access the error logs.

In this embodiment, even it is difficult for the development division to acquire the error logs, it may be possible for the support center to acquire the information equivalent to the error logs based on the error code included in the error message. Namely, the error code includes the information items indicating the version of the program, the name of the file where the error occurred, and the line number of the source file. Therefore, it may become possible for the development division to accurately specify (pinpoint) the place (part) where the error occurred (i.e., which part of which file was being executed when the error occurred).

### Example Configuration

### Program Execution Apparatus

As is described below, to display the line numbers of a source file, there have been line numbers already included in a program to be executed by the program execution apparatus. Therefore, the program execution apparatus in this embodiment may have any appropriate configuration, such as a stand-alone type client terminal and a terminal or a server connected via a network, to execute the program.

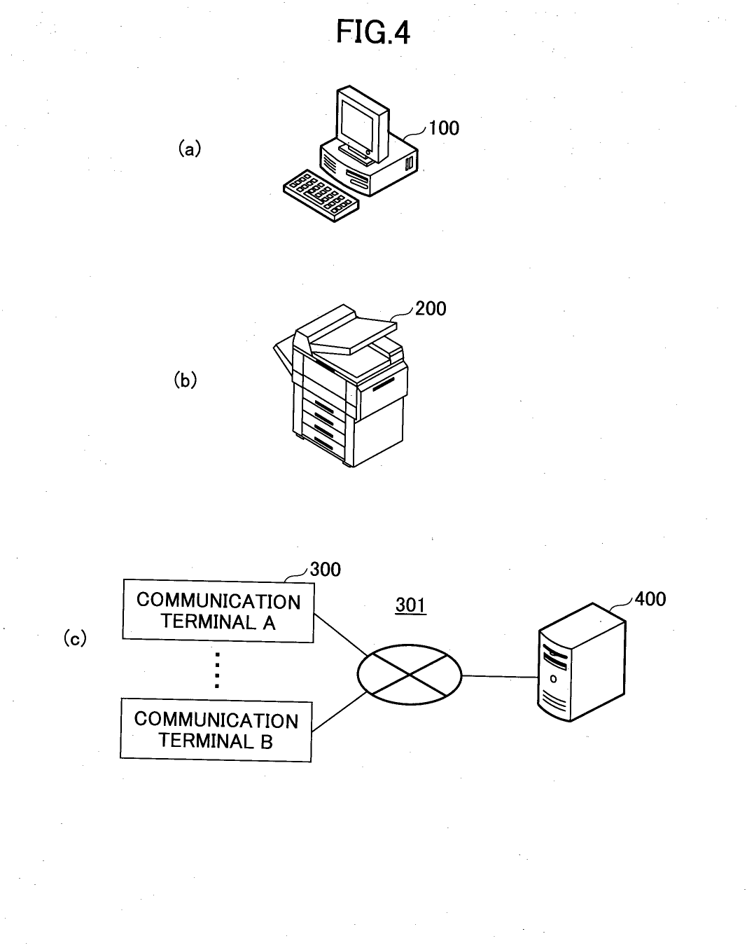

A part (a) of FIG. 4 shows an example of a schematic perspective view of an information processing apparatus 100 as a stand-alone type program execution apparatus. A part (b) of FIG. 4 shows an example of a schematic perspective view of a Multi-Functional Peripheral (MFP) 200. Both the information processing apparatus 100 and the MFP 200 include a Central Processing Unit (CPU) and a program, so that a process specific to the program may be performed by executing the program by the CPU. When an error occurs, the information processing apparatus 100 or the MFP 200 displays the error code.

A part (c) of FIG. 4 shows an example of a schematic configuration diagram of a communication system 301. In the communication system 301, plural communication terminals 300 (hereinafter may be referred to as communication terminals A, B when it is desirable to distinguish one from another) and a server 400 are connected to each other (via a network). The communication terminal A is located in one area (e.g., in the United States) and the other communication terminal A is located in another area (e.g., in Japan), and the communication terminals A, B are communicatively connected to each other via the server 400 and a network.

The communication terminals A, B include respective cameras, speakers, and microphones and are locally connected to respective display devices. A voice (voice sound) of a user near the communication terminal A is collected by the microphone of the communication terminal A and is converted into an electrical signal to be transmitted to the communication terminal B. The speaker of the communication terminal B converts the electrical signal into voice so that the voice is output from the speaker. This applies to the images captured by the cameras as well. Namely, the communication terminal A converts an image captured by the camera of the communication terminal A into an electrical signal to be transmitted to the communication terminal B. The communication terminal B converts the electrical signal into the image to be displayed on the display device of the communication terminal B. This may allow users located in different areas to communicate with each other using the voices and the images. Further, as the display device, for example, a projector or a liquid crystal display may be used. As a specific example of the communication system 301, there has been known a teleconference system.

In the program execution apparatus of FIG. 4, the MFP 200 and the communication terminal 300 may be called s. An error message in this embodiment may be especially effective in such s where the number of operations with respect to the program execution apparatus is limited to the user. Generally, the term “embedded apparatus” may not be well-defined. However, for example, it is assumed that the embedded apparatus does not include general-purpose information processing apparatus (i.e., Personal Computer (PC)).

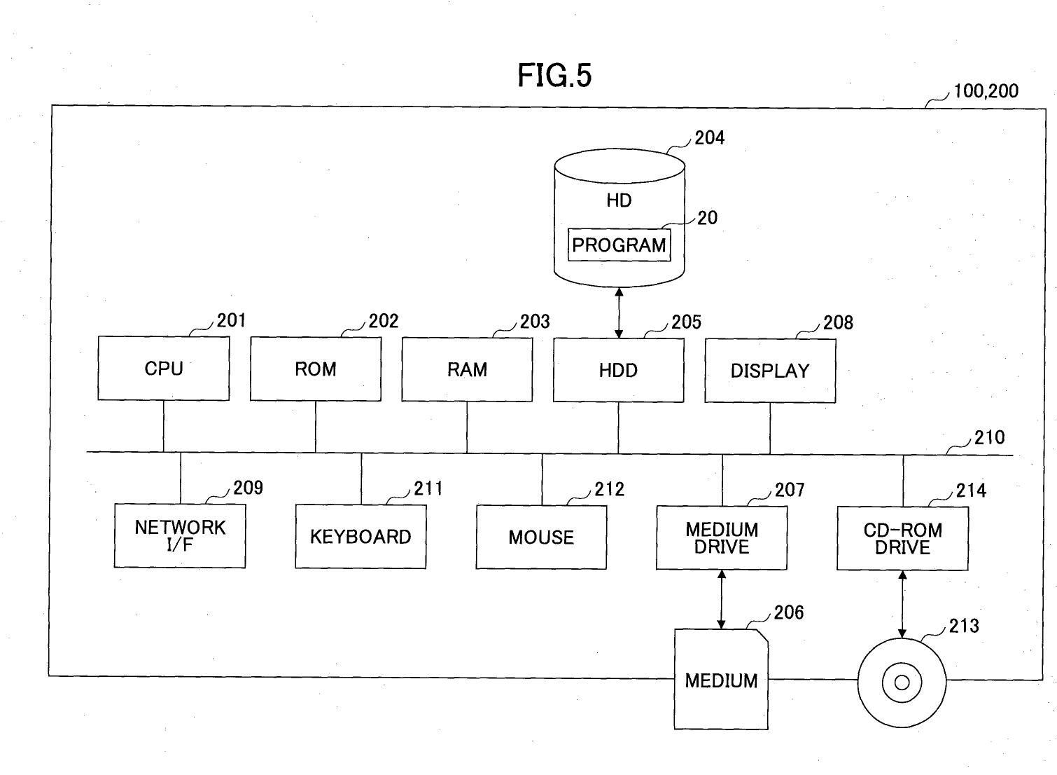

FIG. 5 shows an example of a hardware configuration of the information processing apparatus 100 or the MFP 200. Here, the hardware configuration of the MFP 200 is limited to a part relevant to the execution of a program 20. Namely, besides the functions in the illustrated part, the MFP 200 may (generally) include other functions such a scanner, a plotter, a facsimile machine and the like.

The information processing apparatus 100 or the MFP 200 includes a CPU 201, a Read Only Memory (ROM) 202, a Random Access Memory (RAM) 203, a Hard Disk (HD) 204, a Hard Disk Drive (HDD) 205, a medium drive 207, a display 208, a network Interface (I/F) 209, a keyboard 211, a mouse 212, a Compact Disc Read Only Memory (CD-ROM) drive 214, and a bus line 210. The CPU 201 controls the operations of the entire apparatus. The ROM 202 stores an Initial Program Loader (IPL) and static data. The RAM 203 is used as a work area of the CPU 201. The HD 204 stores the program 20 to be executed by the CPU 201 and various data. The HDD 205 drives the HD 204 under the control of the CPU 201 to write and read various data to and from the HD 204. The medium drive 207 controls reading and writing (storing) data with respect to a recording medium 206 such as a flash memory. The display 208 displays various information including a cursor, a menu, a window, characters, images and the like. The network I/F 209 is an interface for data transmission using a communication network 2. The keyboard 211 includes plural keys to input characters, figures, and various instructions. The mouse 212 is used to select and execute various instructions, select processes to be executed, move a cursor and the like. The CD-ROM drive 214 controls reading and writing various data with respect to a CD-ROM 213 or the like which is an example of detachable recording medium. The bus line 210 includes address bus and a data bus to provide electric connections between configuration elements as shown in FIG. 5.

Here, the program 20 may be a file having an installable format or an executable format, and may be distributed by storing the program 20 into a computer-readable recording medium such as the recording medium 206, the CD-ROM 213 and the like. Further, the program 20 may be a file having an installable format or an executable format from or by a server (not shown) so as to be distributed to the information processing apparatus 100 or the MFP 200.

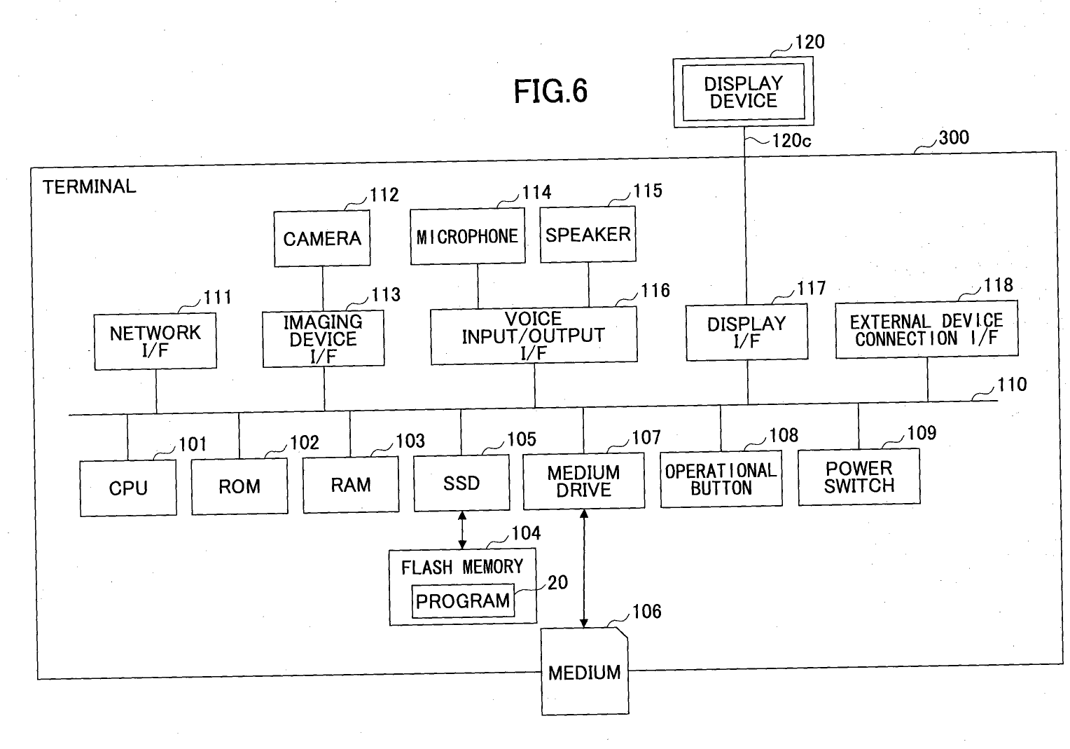

FIG. 6 shows an example of a hardware configuration of the communication terminal 300. As shown in FIG. 6, the communication terminal 300 in this embodiment includes a CPU 101, a ROM 102, a RAM 103, a flash memory 104, a Solid State Drive (SSD) 105, a medium drive 107, an operation button 108, a power switch 109, and a network I/F 111. The CPU 101 controls the operations of the entire communication terminal 300. The ROM 102 stores the IPL and static data. The RAM 103 is used as a work area of the CPU 101. The flash memory 104 stores various data including the program 20, image data, voice data and the like. The SSD 105 controls writing and reading various data with respect to the flash memory 104 under the control of the CPU 101. The medium drive 107 controls writing and reading (storing) data with respect to a recording medium 106 such as the flash memory. The operation button 108 is used to, for example, select a destination of a terminal 100. The power switch 109 is used to turn ON and OFF the power of the terminal 100. The network I/F 111 is an interface for data transmission via the communication network 2. Further, the recording medium 106 is detachably provided with respect to the communication terminal 300.

The communication terminal 300 further includes a camera 112, an imaging device I/F, 113, a microphone 114, a speaker 115, a voice input/output I/F 116, a display I/F 117, an external apparatus connection I/F 118, and a bus line 110. The camera 112 takes an image of an imaging object under the control of the CPU 101 to acquire the corresponding image data, and is embedded in the communication terminal 300. The imaging device I/F 113 is used to control driving of the camera 112. The microphone 114 inputs voice, and is embedded in the communication terminal 300. The speaker 115 outputs voices, and is embedded in the communication terminal 300. The voice input/output I/F 116 performs input and output processes on the voice signal between the microphone 114 and the speaker 115 under the control of the CPU 101. The display I/F 117 transmits image data to an external display device 120 under the control of the CPU 101. The external apparatus connection I/F 118 is an interface for connections with various external apparatuses. The bus line 110 includes an address bus and a data bus to provide electric connections between configuration elements as shown in FIG. 6.

The display device 120 in FIG. 6 is assumed to be a Liquid Crystal Display (LCD) including liquid crystal or an organic EL display displaying an image of the imaging object and icons for operations. However, the display device 120 may be a projector. The display device 120 is connected to the display I/F 117 via a cable 120c.

The camera and the speaker may not be embedded in the communication terminal 300, and may be external types to be externally connected to the external apparatus connection I/F 118 via a Universal Serial Bus (USB) cable or the like.

The program 20 is not always stored in the flash memory 104. This is because, in the communication system 301, the program 20 adapted to the type of the communication terminal 300 may be downloaded from the server 400. However, while the program 20 is outputting an error message, the program 20 may be stored in the flash memory 104. Therefore, the program 20 may be regarded as a part of the communication terminal 300.

The program 20 may be a file having an installable or an executable format, and may be distributed using a computer-readable recording medium such as the recording medium 106 storing the program 20.

### Program Generation Apparatus

In this embodiment, the program 20 to be executed by the program execution apparatus (e.g., information processing apparatus 100, MFP 200, communication terminal 300) includes line numbers of the source file. Therefore, there exists an apparatus that generates such a special program 20 (hereinafter the apparatus is called a program generation apparatus). The program generation apparatus may be an information processing apparatus that runs on an universal (versatile) Operating System (OS) (e.g., Windows (registered trademark), UNIX (registered trademark), Linux (registered trademark)). Therefore, from a functional point of view, there may be not much difference between the program generation apparatus and the information processing apparatus in FIG. 5. However, generally, such a program generation apparatus is at the provider. In this regard, the program generation apparatus may differ from the program execution apparatus executing the program 20.

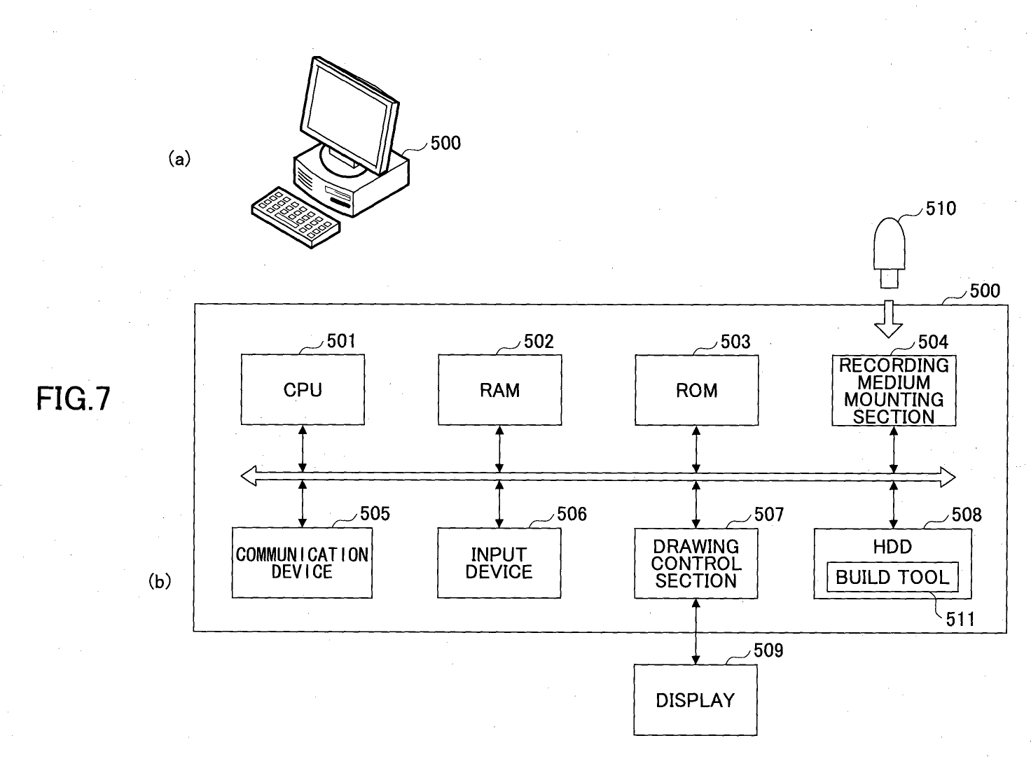

A part (a) of FIG. 7 shows an example of a schematic perspective view of a program generation apparatus 500. A part (b) of FIG. 7 shows an example of hardware configuration of the program generation apparatus 500. The program generation apparatus 500 includes a CPU 501, a RAM 502, a ROM 503, a recording medium mounting section 504, a communication device 505, an input device 506, a drawing control section 507, and an HDD 508. The CPU 501 provides various functions by reading and executing an OS and a build tool 511 from the HDD 508, and performs a process of generating corrected draft image data.

The RAM 502 serves as a work area (main memory) temporarily storing data necessary for the CPU 501 to execute the build tool 511. The ROM 503 stores IPL to start Basic Input Output System (BIOS) and the OS, and static data.

A recording medium 510 is attached to and detached from the recording medium mounting section 504. The recording medium mounting section 504 reads data stored in the recording medium 510 and stores the data in the HDD 508. Further, the recording medium mounting section 504 may write data stored in the HDD 508 into the recording medium 510. The recording medium 510 may be, for example, a USB memory or an SD card.

The input device 506 includes, for example, a keyboard, a mouse, and a trackball, and accepts various operational instructions from a user to the program generation apparatus 500. The HDD 508 may be a non-volatile memory such as a Solid State Drive (SSD), and stores the OS and various data such as the build tool 511.

The communication device 505 is a Network Interface Card (NIC) for connection to a network such as the Internet, and may be an Ethernet (registered trademark) card.

The drawing control section 507 interprets a drawing command having been written in a graphic memory by executing the build tool 511 by the CPU 501, and draws on a display 509 thereby generating a screen.

The build tool 511 is a file having an installable format or an executable format, and may be distributed with the recording medium 510 storing the build tool 511 or by a server (not shown).

### Functional Blocks

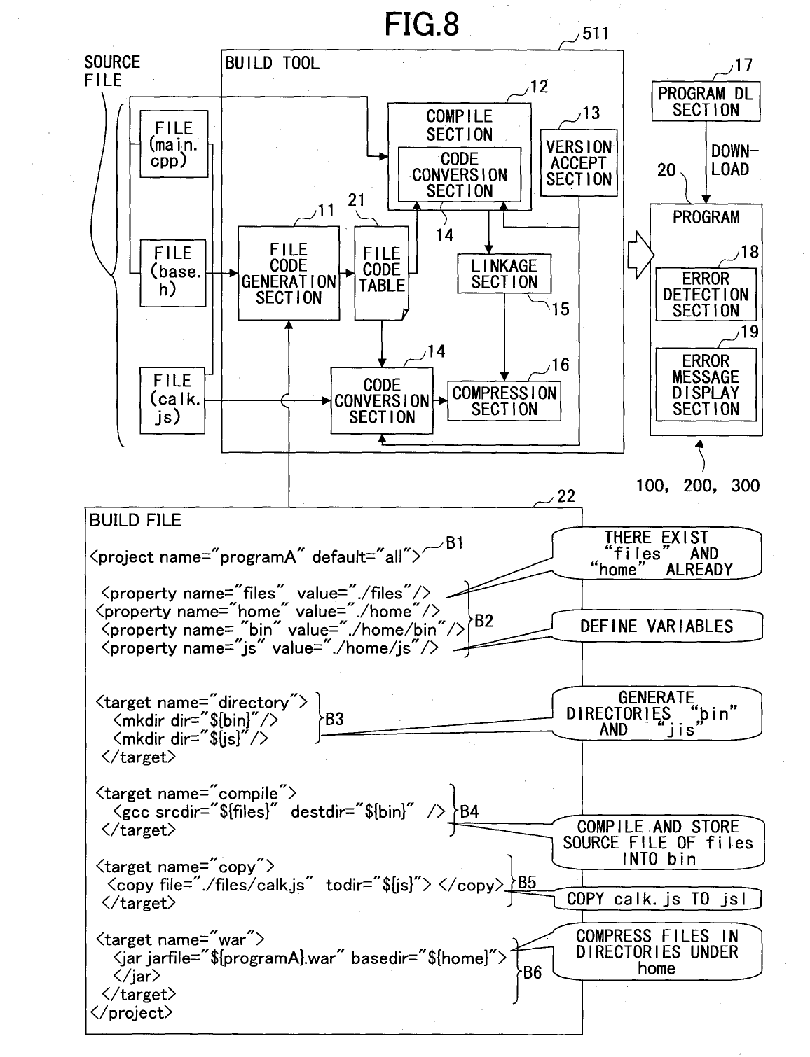

FIG. 8 shows an example of a functional block diagram of the program generation apparatus 500 and the program execution apparatus. The program generation apparatus 500 builds a source file using the build tool 511, and generates the program 20. The build tool 511 includes a compile section 12, a linkage section 15, a compression section 16, a file code generation section 11, a version accept section 13, and a code conversion section 14. Among these, the code conversion section 14 may be independently provided or included in the compile section 12 as a part of the compile section 12.

The compile section 12, the linkage section 15, and the compression section 16 are known functions provided by the build tool 511. Namely, the compile section 12 compiles a source file written (described) in C, C++, JAVA (registered trademark, hereinafter omitted) or the like, and generates an object module file for each source file. Then, the linkage section 15 links plural object module files to generate an object file.

The compression section 16 combines and compresses files in the directory along with a designated directory structure, so that the compressed files have an file extension such as “*.jar”, “*.war”, “*.exe” and the like. The compressed file is the program 20. The program execution apparatus may decompress and execute the compressed program 20, and may directly execute the program as an executable file.

The operational contents of the build tool 511 are defined by a build file 22. The build file 22 is described in the eXtensible Markup Language (XML) and defines a build method how to build the source file and generate a project (i.e., the program in this embodiment).

Description B1 defines “program A” as a project name.

Description B2 defines variable names, and stores directory names “files”, “home”, “bin”, and “js” as variables. Here, the “files” and the “home” have existed already.

Description B3 defines to generate directories “bin” and “js”.

Description B4 defines (directs) to compile the source file in “files”, and copy it to a file “bin”.

Description B5 defines (directs) to copy the file “calk.js” in files to a directory “js”.

Description B6 defines (directs) to compress directories and files under “home” and generate compressed file “programA.war”

When a developer (development engineer) directs the start of build, the build tool 511 reads such as a build file 22 and starts the build. The build file 22 may be described by a developer, or may be automatically generated by analyzing the file contents of the source files under development by the build tool 511.

The file code generation section 11 specifies all target files to build, associates the files with unique file codes (identification information), and generates a file code table 21. In the build file 22 of FIG. 8, all target files to build are files in the file directory to be compiled and the file calk.js of copy source. Therefore, the file codes not used for the files in the file directory may be given.

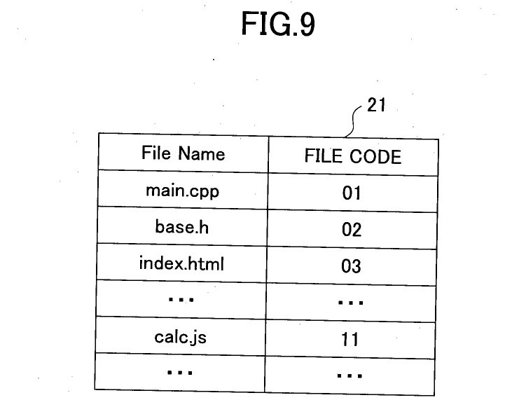

FIG. 9 shows an example of the file code table 21. In the file code table 21, file codes which are unique to each other are associated with all the files which are original files to constitute the program 20. The file code generation section 11 refers to, for example, the build file 22, and extracts all the source files in files to be compiled in Description B4 and the source files which are copy sources in Description B5. Then file codes are given to those files.

The file code table 21 may be generated by a developer. In this case, the file code generation section 11 may not be necessary.

The version accept section 13 accepts the input of the version of the program 20 from the developer. The version of the program is described below.

Further, the code conversion section 14 converts the specific functions described in the files into the version, the file codes, and line numbers of the source file of the program 20 (after conversion into hexadecimal). Namely, the error code is generated. Due to this conversion, it may becomes possible to display the line number of the source file by the program 20 when an error occurs.

Whether the code conversion section 14 is included in the compile section 12 or is outside of the compile section 12 is to correspond to whether the target file to build requires compiling or not. Therefore, the contents of the process may be identical. For example, a file described in JavaScript (registered trademark, hereinafter may be omitted) is not to be compiled. Therefore, the code conversion section 14 outside of the compile section 12 generates the error code. On the other hand, a file described in C++ or JAVA is to be compiled. Therefore, the code conversion section 14 in the compile section 12 generates the error code. If the code conversion section 14 generates the error code before the compiling, only the code conversion section 14 outside of the compile section 12 may be mounted.

The program 20 that has been generated by the build tool 511 as described above includes an error detection section 18 and an error message display section 19 in addition to various functions specific to the program 20. The error detection section 18 detects occurrence of an error by determining the contents of the variables using if sentence and the like. The error message display section 19 detects the occurrence of the error and draws an error message on the displays 208, 120.

Further, a program DL section 17 is mainly mounted on the communication terminal 300. For example, when the power of the communication terminal 300 is turned ON, the IPL starts to cause the CPU 101 to execute the program DL section 17. The program DL section 17 connects to the server 400 by designating the IP address of a known server 400 using, for example, a FTP command, and downloads the program 20 from the server 400 by designating the file name of the program 20 using a get command.

Further, when the power of the communication terminal 300 is turned OFF, the communication terminal 300 deletes the program 20 in the flash memory 104. By doing this, it may become possible to prevent the program 20 from being stolen from the communication terminal 300.

### Version of Program

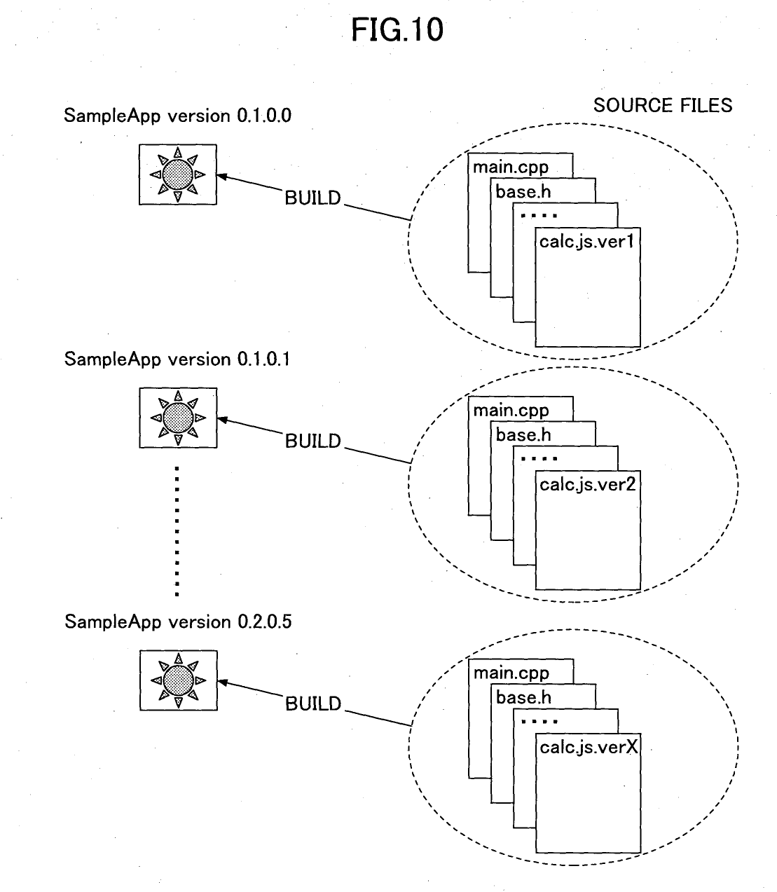

FIG. 10 is an example illustrating the version of the program 20. The program 20 having a certain scale is generated via the process called build based on plural source files. FIG. 10 shows a case where a single program 20 is generated based on a C++ language source file called main.cpp, a header file used by main.cpp called base.h, a JavaScript source file called calk.js (this also is called a source file because JavaScript is not compiled but is a target of build) and the like.

Here, the term “build” refers to generating a “executable file” by combining those files. It is the program generation apparatus 500 that performs the “build”, the program generation apparatus 500 being used by the developer. Generally, the build tool 511 such as “Make” and “ANT” is commercially available. By executing the build tool 511 by the program generation apparatus 500, an executable file which is the program 20 (e.g., *.war, *.jar, *.exe files) may be generated.

Then, by the combination of the versions of those plural files, the version of the program 20 is managed. For example, when only the version of calk.js is changed (i.e., when only the calk.js is updated and any other files are not changed), the version of the program 20 is updated by the version of the calk.js. FIG. 10 shows cases as follows:

Calk.js Ver1: Version of the program is 0.1.0.0
Calk.js Ver2: Version of the program is 0.1.0.1
Calk.js VerX: Version of the program is 0.2.0.5

For example, the version of the program 20 is set by the developer when the build is performed. The version of the program 20 may be managed by, for example, recording the version of the program 20 along with the versions of the source files by the developer. However, a dedicated version management system is often used. As the version management system, there have been known, for example, a Concurrent Version System (CVS), a Subversion (SVN), and a Git which are freeware, and a VisualSourceSafe (registered trademark). In a case of the SVN, the version of the program 20 is given as follows:

s1): A developer registers a directory structure in a repository by using a commend (import) of the version management system, the directory structure including source files registered in a tree-shape. The repository is the area where resources (source files and the like) are stored. At this moment, the version management system gives revision 1 as the initial version to the project.
s2): There is a case where the developer edits one or more source files. When the developer wishes to record the combination of the source files having been edited, the developer uses a command (commit) of the version management system to store the edition result into the repository. The version management system increases the revisions of the project to 2, and adds the new version to a new source file.
s3): When the program 20 is generated from the project by performing the build on the source files, the developer uses a command (copy) of the version management system to give a tag name. By giving the tag name, the versions at that time of the source-files or the source files having different versions are associated with the tag name and stored by the version management system. Generally, the tag name is given as “tag=version of program 20”.

By giving the tag name, once the version of the program 20 is known, the version management system uniquely specifies the source files used for the build.

Afterward, by the operations of the developer, the build tool 511 performs the build in a manner that the directory structure and the contents of the source files are unchanged (i.e., no new change is added) since the tag name is given. When the build is performed, the developer designates the tag name as the version of the program 20.

Afterward, when the source files corresponding to the version of the program 20 are to be taken, the developer designates the tag name to specify the source files.

Further, there exists the IDE that performs both build and version management. Therefore, it may not always necessary to provide the build tool 511 and the version management system separately.

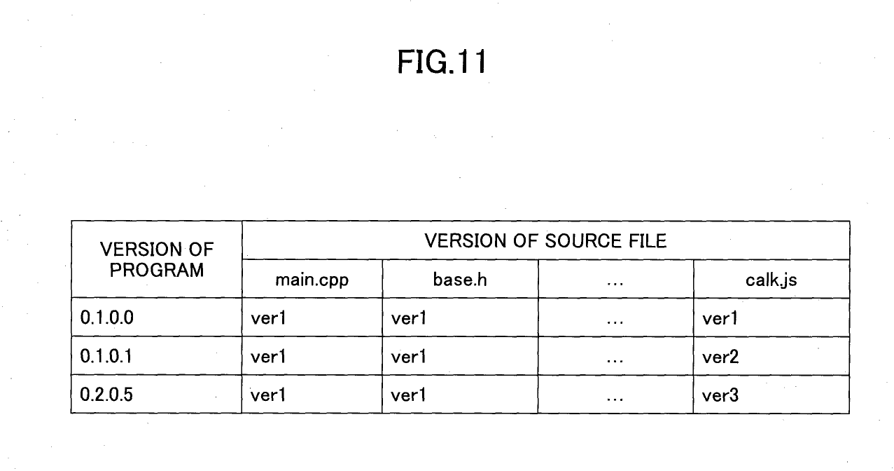

FIG. 11 shows an example of a version management table generated by the build tool 511. The build tool 511 acquires the version or the time stamp of the source files, and associates and registers the acquired version or the time stamp with the version of the program 20. Therefore, when the version of the program 20 is detected, by referring to the version management table, the version of the files included in the program corresponding to the version may be specified. The version management table is managed by the development division.

Further, in the source files of FIG. 10, types (e.g., the description languages) may differ. However, the build tool 511 may perform the build only on the files having the same type (e.g., only files described in C++). In this case, the build tool 511 performs only compile and link. Whether such a partial process is called the build or compile, it is a matter of name only. Namely, even when the source files have a single type, the program execution apparatus may display the line numbers.

### Error Code

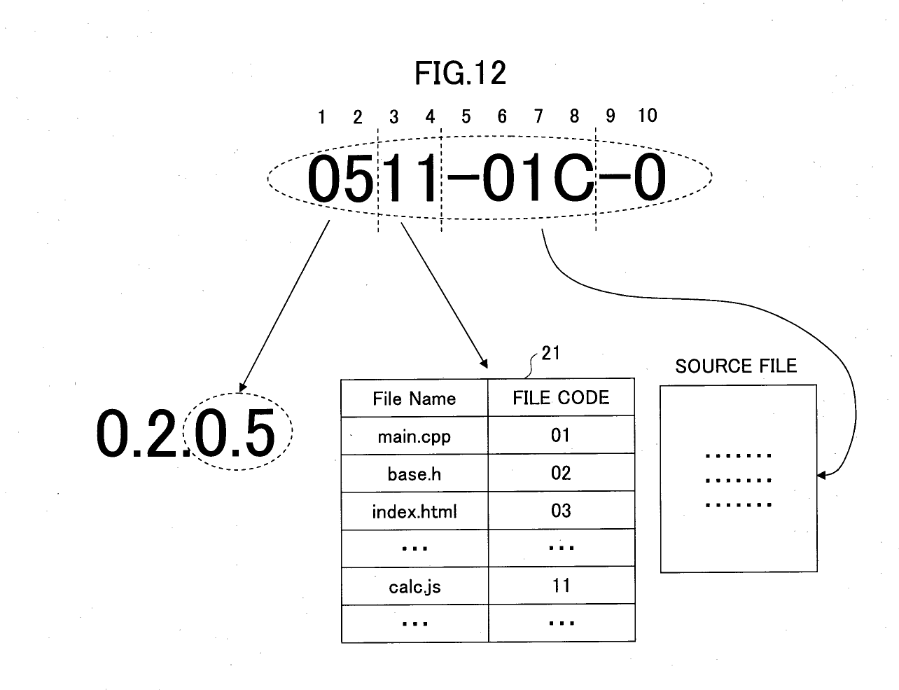

FIG. 12 shows an example of the error code. In FIG. 12, the error code has a total of 10 digit characters (digits). The error code is described by adding (counting) the digit numbers from the left-most digit. The first two digits of the error code denote the last two digits of the version of the program 20. For example, when the version of the program 20 is “0.2.0.5”, the data are “05”. The reason why only 2 digits are used is to reduce a risk of reporting a wrong number to the service center compared with a case where a longer error code is required to be reported. Further, the error code includes “−” (hyphen), so that the error code may become more readable and there is no meaning in the hyphen.

It may depend on how to describe the version, but when the developer increments the version one by one as a decimal, 100 versions are identified when last two digits are used. Therefore, it may be sufficient (enough capacity) to analyze the error code using the last two digits of the version alone.

The two characters in the third and fourth digits in the error code denote a file code of the source file outputting an error message. As described with reference to FIG. 9, the file code is a hexadecimal number uniquely identifying the file name of the source file. With two digits in hexadecimal, 255 files may be identified. The file code may be insufficient for file codes in a large-scale program 20, but may be sufficient for the program having a general scale. When the file code becomes insufficient, the fifth digit for the hyphen may also be used to increase the number of digits for the file code. Why the file name is expressed and displayed by using the file code is not only to reduce the length as much as possible but also to prevent the information including the function of the program 20 from being known to the users and the like based on the file name.

The three characters of sixth to eighth digits denote the line number in hexadecimal of the source file outputting the error message. When three digits in hexadecimal are used, as many as 4096 lines are expressed. When the code amount of one source file is greater, the capacity may be insufficient. However, it is thought that the capacity may be sufficient in many cases. However, if 4096 lines are not sufficient, the ninth digit for the hyphen may also be used to increase the number of digits for the line number. The reason why hexadecimal is used to express the line number is to reduce the length of the error code.

One character in tenth digit may be arbitrarily used. For example, the developer of the source file may use this to describe information effective to analyze the error cause when generating the source file. Use of the arbitrary one letter may make easier for the developer to analyze the error cause.

### Example of Source File

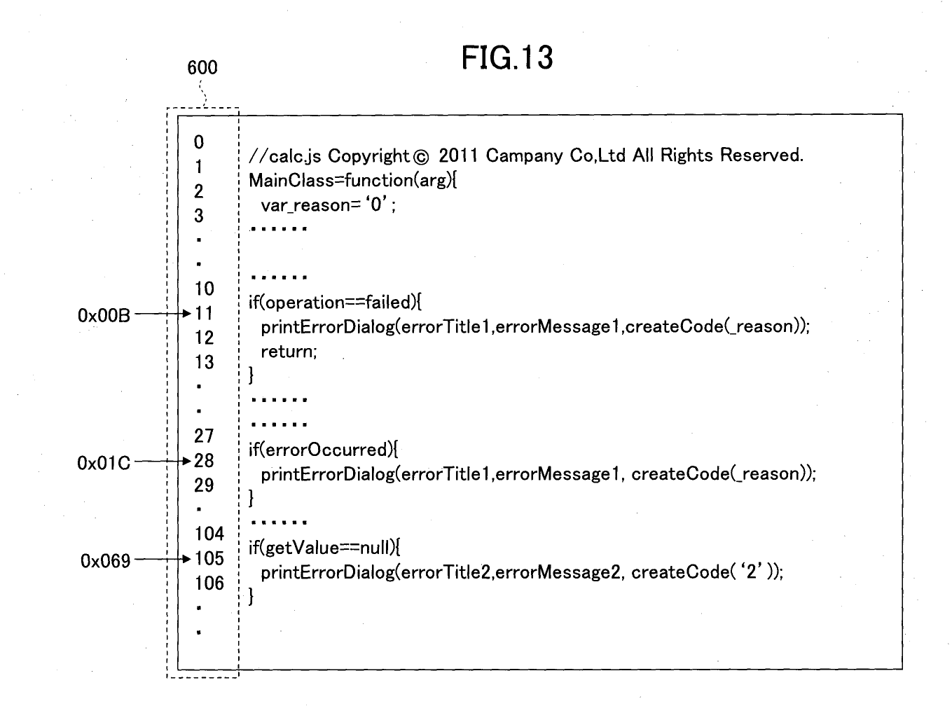

FIG. 13 shows an example of the description of the source file. The source file of FIG. 13 includes line numbers in integers increasing one by one. In the actual source file, no line numbers are included. However, in the IDE and an editor, sequential numbers increasing one by one are added to support the developer.

In FIG. 13, a function called “printErrorDialog” is used to display the error message (see lines 11, 28, and 105). When the function is executed by the program execution apparatus, the program execution apparatus displays the error message having a format as in FIG. 2 (i.e., including Descriptions 1-3, and one OK button).

This function takes three arguments: printErrorDialog (errorTitle1, errorMessage1, createCode (_reason).

The first argument “errorTitle1” designates Description 1 in FIG. 2, and the second argument “errorMessage1” designates Description 2. In “errorTitle1” and “errorMessage1”, a character string is set in the line (not shown). The character string is stored in a predetermined address of the RAMs 203, 103, the HD 204, and flash memory 104. When the function is executed, the program execution apparatus reads the character string at the address designated by the “errorMessage1” and the character string at the address designated by the “errorMessage1” from the RAMs 203, 103, the HD 204, and the flash memory 104.

The third argument “createCode ( )” of the function “printErrorDialog” corresponds to Description 3, and becomes an replacement target with the error code. The createCode( ) is a function to generate the error code and takes one argument. When the “printErrorDialog” is executed, the createCode( ) may not be used due to the character string. Therefore, not the function but a variable may be replaced with the error code. The createCode( ) function displays the error code in the error message of related art. Therefore, by exchanging the function with the error code, the developer may change the source code so as to display the error code in this embodiment by using the original source file.

The code conversion section 14 replaces the createCode( ) for the version, the file code, and the line numbers of the program 20, and further replaces the argument of the createCode( ) with an arbitrary one character of the error code. The arbitrary one character is given as a variable in the createCode( ) in lines 11 and 28, and is given as a character constant “2” in line 105. As in line 3, it is described that “_reason=“0””. Therefore, by exchanging the createCode( ) in line 11 with createCode( ) in line 28, the arbitrary one character is “0”. On the other hand, when the createCode( ) in line 105 is replaced, the arbitrary one character is “2”. What the arbitrary one character means may be managed by the developer of the source file using, for example, a table associating the one character with the contents (meaning).

In FIG. 13, three “printErrorDialog” functions are described in lines 11, 28, and 105, respectively. The developer may change the arguments depending on the place or state of an error having occurred (i.e., depending on the last process). Therefore, contents of Descriptions 1 and 2 may also change. Naturally, as in lines 11 and 28, plural “printErrorDialog” functions may have the same argument.

As described above, even the developer may not easily specify or may not specify where the error message is output from at all when only Descriptions 1 and 2 are provided and the same message is used in plural parts. However, by embedding the error code in the source code as in this embodiment, even when Descriptions 1 and 2 are the same, it may become possible to uniquely determine from which part (line) of which source code the error message is output.

For example, if the line number 28 line is included in the error code, the developer may specify that the output error message is displayed due to the “printErrorDialog” function in line 28 of the source file. Therefore, the developer may specify that there is a process that may cause the error, the process being near the line 28 of the source file. In the example of FIG. 3, the process which may cause the error is located several lines before the line number included in the error code.

Just before the “printeErrorDialog” function, a process of determining the occurrence of an error using, for example, an if sentence is described. As the process of determining the occurrence of an error, the developer typically describes an optimal determination condition so as to detect whether an error occurs based on an error which is assumed to have occurred in the process just before the process of determining the occurrence of the error. For example, the error message in line 11 is displayed when the value called “failed” is set in the variable “operation”. The error message in line 28 is displayed when a value other than “0” is set in the variable “errorOccurred”. The error message in line 105 is displayed when the value “null” (nothing) is set in the variable “getValue” Therefore, it may become possible to reliably detect errors specific to the processes. The variable “operation”, the variable “errorOccurred”, and the variable “getValue” are practically stored at predetermined addresses in the RAMs 203, 103, the HDD 204, and flash memory 104. When the program execution apparatus accesses the address based on the variable name, the occurrence of the error may be determined.

Here, the determination of the occurrence of an error using the if sentence is an example only. For example, the occurrence of an error may be determined using a Switch sentence.

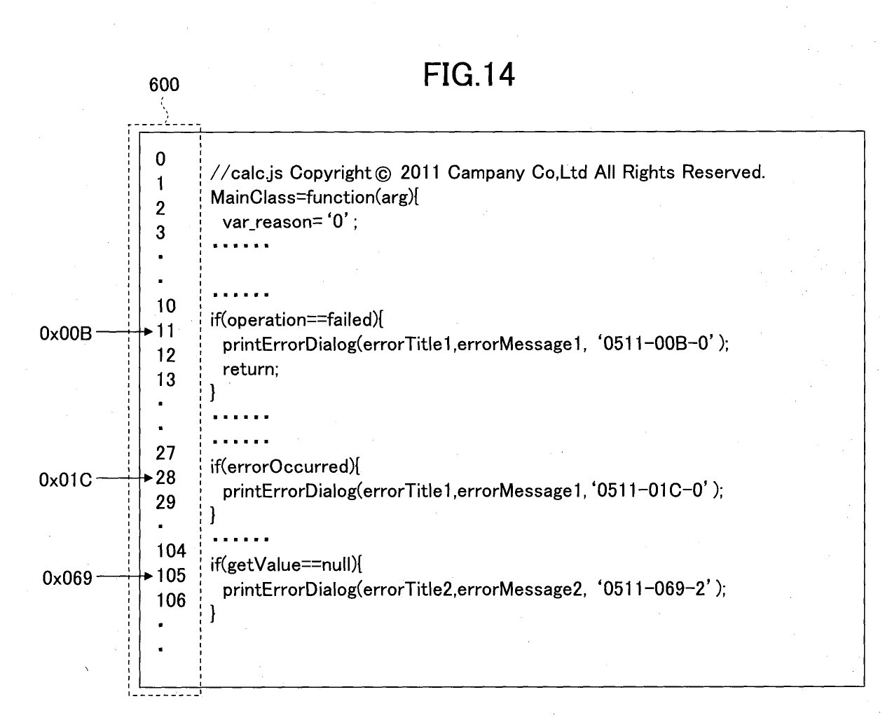

FIG. 14 shows an example of a source file including replaced error codes.

As is apparent when compared with FIG. 13, the CreateCode (_Reason) in line 11 is replaced with 0511-00B-0; the CreateCode (_Reason) in line 28 is replaced with 0511-01C-0; and the CreateCode (“2”) in line 105 is replaced with 0511-0690-2.

### Operational Procedure

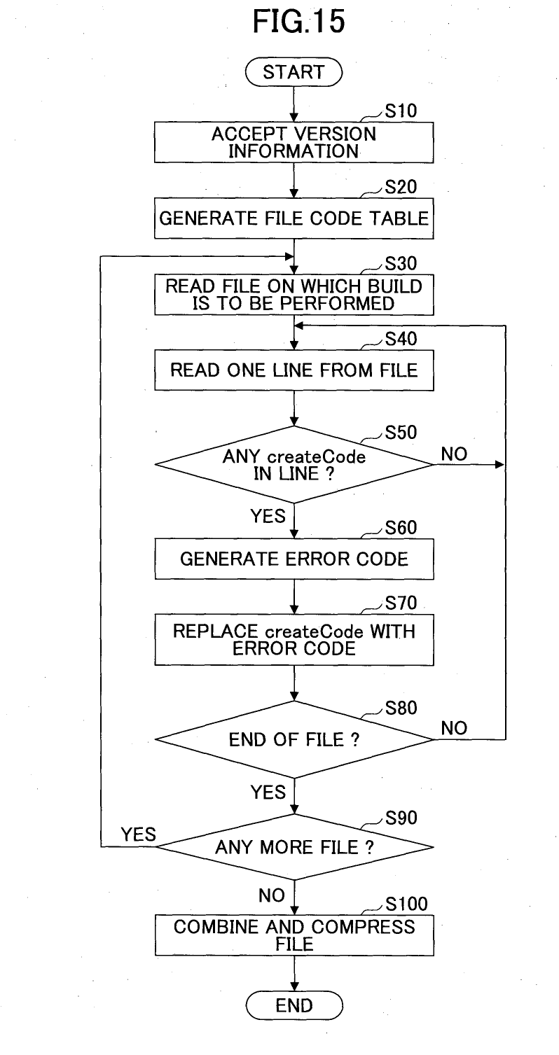

FIG. 15 is an example of a flowchart showing a process of generating the error code by the program generation apparatus 500. Here, in the process, a case is described where the code conversion section 14 is provided outside the compile section 12. However, if the code conversion section 14 is provided outside the compile section 12, the execution timings may differ, but the contents of the process are the same.

Upon performing the build on the files, the developer may set the version of the program 20 after the build to the program generation apparatus 500 (step S10). The version accept section 13 of the program generation apparatus 500 accepts the input of the version.

Next, the file code generation section 11 generates the file code table 21 (step S20). The source file on which the build is to be performed may be specified from the build file 22. In the example of the above figure, the files under the files directory correspond to the source file on which the build is to be performed.

Next, the code conversion section 14 sequentially reads source files that have been targets to generate the file code table 21 (step S30). By doing this, the file codes of currently focused on source files may be specified.

After reading new source files, the code conversion section 14 sequentially reads instructions from the first line (step S40). Even when one instructions are described in two or more lines, the instruction is read line by line. Namely, the instructions may be read without being influenced by a format or grammar of the instructions. Further, difference in one or two lines may not become a significant failure to specify the cause of an error. Therefore, the entire single instruction described in two or more lines may be collectively read.

Next, the code conversion section 14 determines whether the createCode( ) function is included in the read lines (step S50). The argument of the createCode( ) function may have any value or may be none.

When determining that the createCode( ) function is not included (NO in step S50), the process goes back to step S40.

When determining that the createCode( ) function is included (YES in step S50), the code conversion section 14 generates the error code (step S60). In generating the error code, the version, the file code, and line number of the program 20 are used. The above-described arbitrary one character may be or may not be replaced. The code conversion section 14 acquires the version of the program 20 that is input in the program generation apparatus 500 by the developer, and extract last two digits. Next, the code conversion section 14 reads the file code from the file code table 21, the file code corresponding to the file name of the currently focused on file. Next, the currently read lines are used to be the same line numbers, and are converted into hexadecimal. Further, if there is an argument of the createCode( ) function, the arbitrary character is specified. Further, the line of the process where an error occurred is generally several lines before the currently read line. Therefore, a value obtained by subtracting several lines from the currently read line may be determined as the line number and converted into hexadecimal. Then, the error code may be generated by arranging the character strings and hyphens at the respective predetermined positions.

The code conversion section 14 replaces the createCode( ) function with the generated error code (step S70).

Then, the code conversion section 14 determines whether the process is performed to the last line of one source file (step S80). When determining that the process is not performed to the last line (NO in step S80), the process goes back to step S40. When determining that the process is performed to the last line (YES in step S80), the process goes to step S90.

When the process is performed to the last line, the code conversion section 14 determines whether there is any file on which the build is to be performed and on which the process has not been performed yet (from among the all source files in the file code table 21) (step S90).

When determining that there is such a file on which the build is to be performed and on which the process has not been performed yet (YES in step S90), the process goes back to step S30 to repeat processes from step S30. When determining that there is no file on which the build is to be performed and on which the process has not been performed yet (NO in step S90), a build section combines and compresses the files (step S100). More specifically, the compile section 12 compiles the source files to be compiled, and the linkage section 15 links and stores in a specific directory. Further, the build tool 511 copies a source file to be copied only to a specific directory. Finally, the compression section 16 combines and compresses plural files under the directory designated by the build file. By doing this, the program 20 which is an execution file is generated.

The generated program 20 is installed into the program execution apparatus via a recording medium or a network. The program 20 is downloaded to the communication terminal 300 from the server 400 upon the power being turned ON.

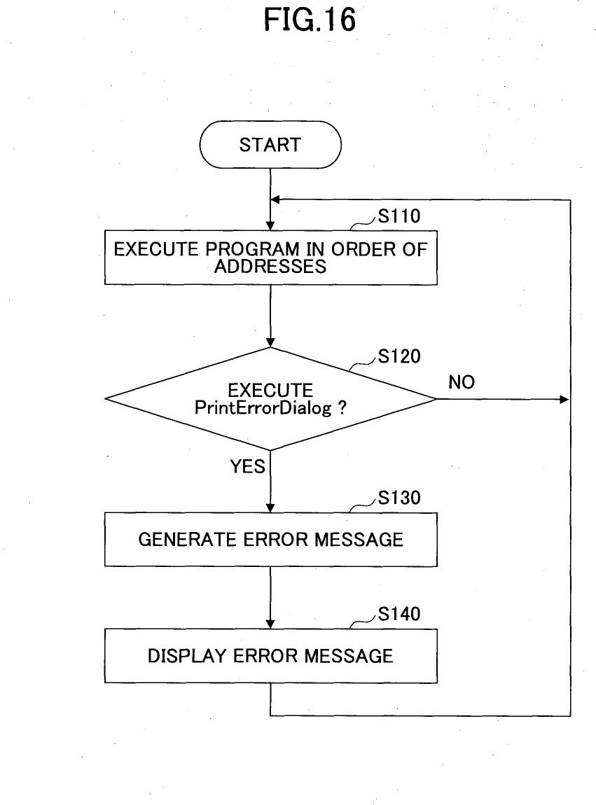

FIG. 16 shows an example of a flowchart illustrating a process of displaying the error message when the program execution apparatus executes the program 20.

The program execution apparatus executes the program 20 in the order of addresses without any call to a branch or a subroutine (step S110).

Then, it is determined whether an error in, for example, an if sentence is detected (step S120). When the error detection section 18 determines that an error is detected (YES in step S120), the error message display section 19 generates an error message (step S130). Specifically, the character sting associated and stored with errorTitle1, the first argument of the PrintErrorDialog function, is read from the RAMs 203, 103, the HDD 204, and the flash memory 104. Further, three arguments, which are, for example, “0511-00B-0” are read from the RAMs 203, 103, the HDD 204, and the flash memory 104. The positions where Descriptions 1-3 are disposed are designated as attributes of the PrintErrorDialog function when the developer generates the source file.

The error message display section 19 displays the error message on the displays 208, 120 and the like (step S140). By doing this, as shown in FIG. 2, the line number where an error occurs is displayed in the error code, so that the user may report the error code to the support center. When the user presses the OK button, the program execution apparatus resumes the process from the next instruction in the PrintErrorDialog function.

The support center or the development division refers to the version management table, and specifies the versions of the files corresponding to the version of the program 20 included in the error code. Next, the support center or the development division refers to the file code table 21, and specifies the file name corresponding to the file code included in the error code. By doing this, the source file where the error occurs and the version of the source file may be specified. The support center or the development division specifies where the error occurs in the source file based on the line number included in the error code. Therefore, the instruction where the error occurs may be specified (pinpointed).

### Embodiment 2

In this embodiment, the program execution apparatus and the program generation apparatus displaying an error code different from that in Embodiment 1 are described.

### Error Code

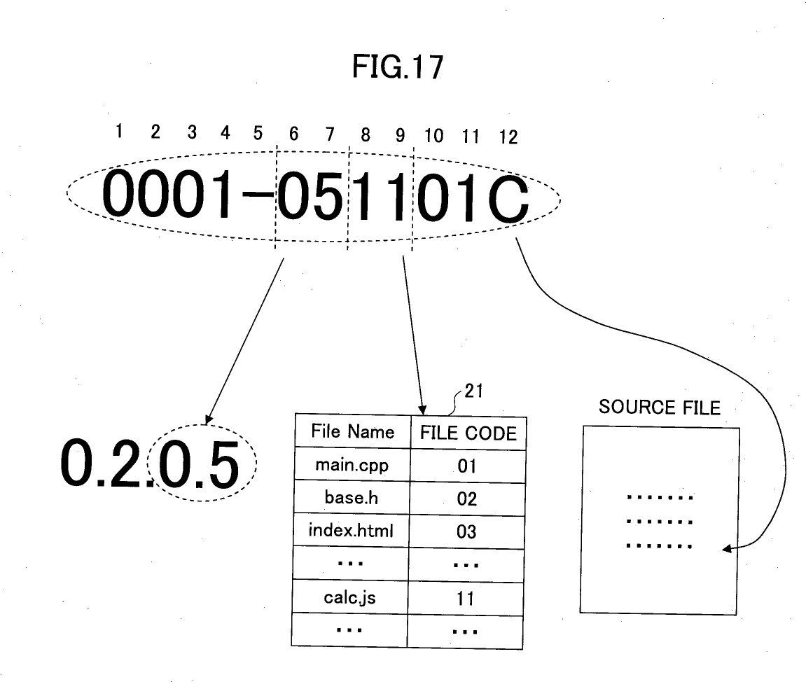

FIG. 17 shows an example of an error code in this embodiment. The error code in FIG. 17 has total twelve digits. The digits numbers are given to the digits from the left end and described. In this embodiment, a feature is that an error number is given using four-characters in 1-4 digits of the error code.

Here, the error number refers to identification information uniquely (or collectively) identifying error contents. In the error code in Embodiment 1, it is assumed that the developer refers to the source code to analyze the error code, and the user reports the message and the error code to the support center. Therefore, if the message or the error code is long, or if there are some messages and error codes resembling others, messages or error codes may not be reported correctly.

The upper four digits of the error code are for resolving the problem. Further, the upper four digits of the error code may be used by preparing and distributing a manual including the error contents and resolving measures corresponding to the error codes or providing a Web page displaying the error contents and resolving measures corresponding to the error codes by the manufacturer of the program execution apparatus. Further, it may become possible to increase the likelihood that the user may resolve the cause of an error of the program by referring to the manual or the like based on the upper four digits of the error code without contacting the support center.

The hyphen in fifth digit in the error code is a symbol to distinguish the error number from other parts. To that end, the hyphen is not always desired, and, for example, the symbols of “_”, “:”, “/”, or space “ ” may be used. Further, the error code may also be described without the hyphen and the like.

The two characters in the sixth and the seventh digits are the same as those in the first and the second digits (i.e., the last two digits in the program 20) in the error code of FIG. 12, and the two characters in the eighth and the ninth digits are the same as those in the third and the fourth digits (i.e., the file code of the source file where an error message is output) in the error code of FIG. 12.

The hyphen in the fifth digit of the error code of FIG. 12 is omitted in the error code of FIG. 17. This is because, in the error code of FIG. 17, by using only one hyphen at the fifth digit, the error number may be more clearly separately from the other part. The code (6-12 digits) other than the error code is used by the development division similar to Embodiment 1. Further, by omitting the hyphen, it may become possible to prevent the length of the error code from being too long.

The three characters in 10-12 digits are the same as those in 6-8 digits in the error code of FIG. 12 (i.e., the line number of the source file).

Further, there is nothing corresponding to the characters in 9-10 digits in the error code of FIG. 12. The reason of this to prevent the error code from being too long. However, the characters in 9-10 digits in the error code of FIG. 12 may be added in 13-14 digits of the error code of FIG. 17 without being omitted.

Further, the error number is described in the upper 1-4 digits. However, the position of the error code is not limited to the upper 1-4 digits. The positions where the version of the program 20 and the line number of the source file are described are not limited to the positions as described in FIG. 17. The number of digits of the error code is not limited to four. Less than or more than 4 digits may be used for the error number.

### Example of Source File

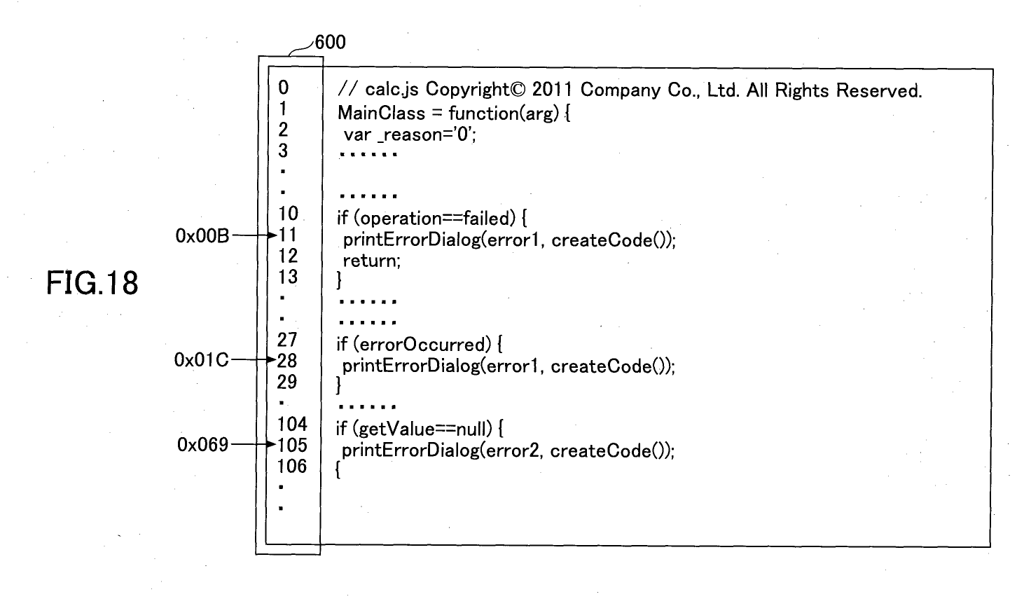

FIG. 18 shows an example of the descriptions of the source file. With respect to parts common between FIG. 13 and FIG. 18, only main parts are described. Similar to Embodiment 1, the “printErrorDialog” function is the function to display the error message. However, the prinErrorDialog function takes two arguments.

The first argument error1 (or error2) is associated with the error number in the error number table. Further, due to the association between the first argument and the error number, Descriptions 1 and 2 associated with the first and the second arguments, respectively, in Embodiment 1 are registered in the error number table so as to be associated with the first argument. Therefore, the second argument in Embodiment 1 may be omitted.

The third argument createCode( ) is to be replaced with the error code. Further, in this embodiment, the error code does not include an arbitrary one character. Therefore, the argument of createCode( ) is not used.

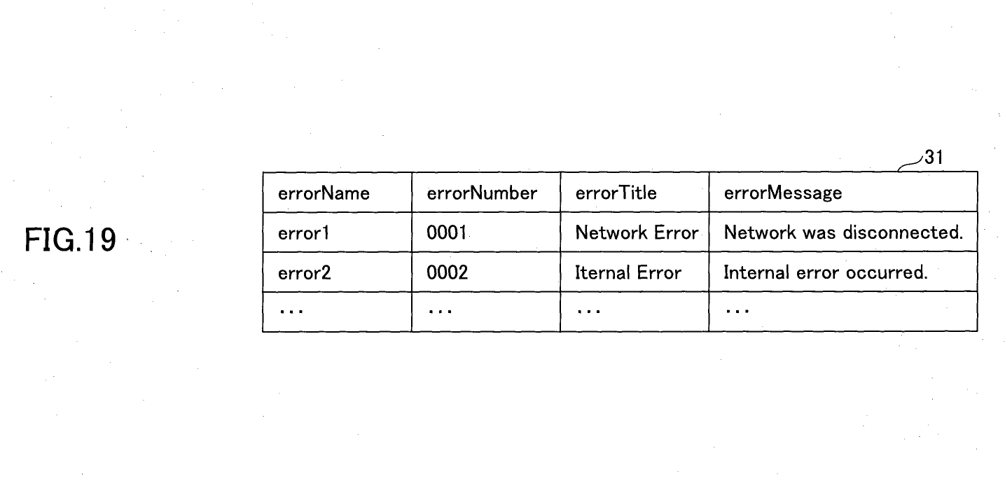

FIG. 19 shows an example of an error number table 31 where the first argument is associated with the error number, and Descriptions 1 and 2. The error number table 31 is stored in, for example, the HDD 508 of the program generation apparatus 500 and the HD 204, SSD 105 and the like of the program execution apparatus. The error number table 31 includes fields “errorName”, “errorNumber”, “errorTitle”, and “errorMessage” as follows:

“errorName” registers that value to be the first argument of “printErrorDialog” function;
“errorNumber” registers the error number in the error code;
“errorTitle” registers the error name (brief contents of the error); and
“errorMessage” registers the error message (specific contents of the error).

As described above, the first argument of printErrorDialog function of the source file is registered as “errorName”. Further, in Descriptions 1 and 2, “errorTitle” and “errorMessage” are displayed, respectively.

The code conversion section 14 refers to the error number table 31 based on the first argument, and reads the error number and Descriptions 1 and 2. Further, the code conversion section 14 replaces the createCode( ) with the error number, and the version, the file code, and the line number of the program 20. By doing this, the createCode( ) may be replaced with the error code.

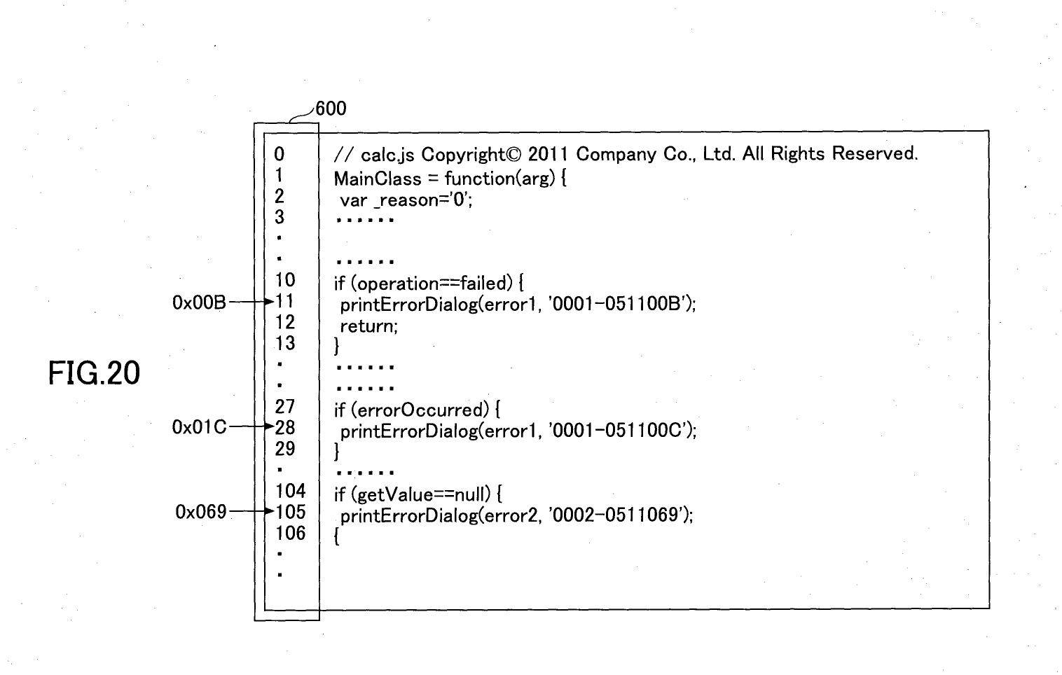

FIG. 20 show an example of the source file including replacement error codes.

As may be apparent when compared with FIG. 18, the createCode( ) in line 11 is replaced with “0001-051100B”, the createCode( ) in line 28 is replaced with “0001-051101C”, and createCode( ) in line 105 is replaced with “0002-0511069”.

As described above, the first to fourth digits of the error code are replaced with the error number.

### Operational Procedure

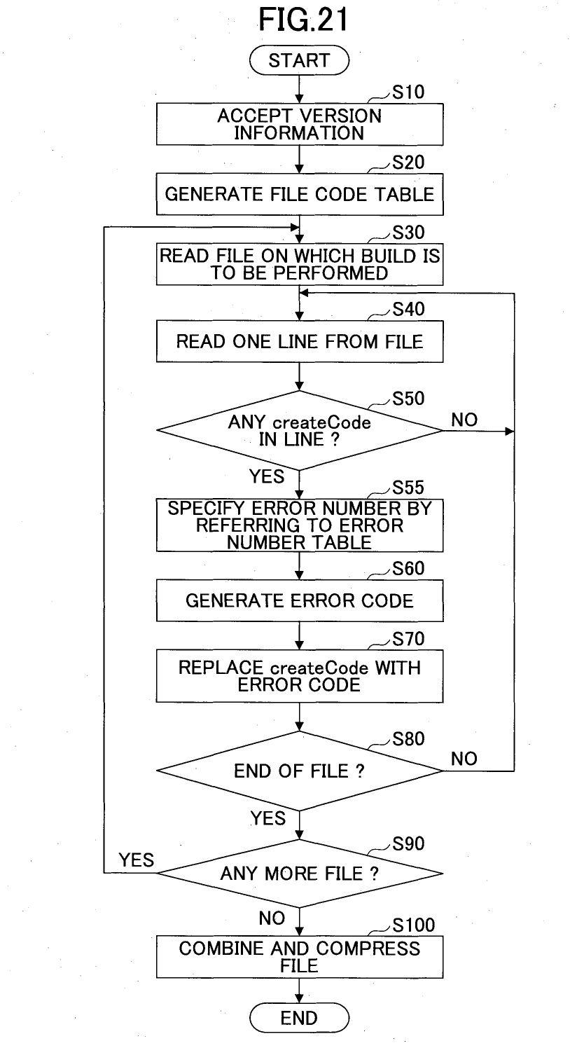

FIG. 21 shows an example of a flowchart illustrating a process of generating the error code by the program generation apparatus 500. The procedure in FIG. 21 differs from that in FIG. 15 in that a step S55 is added.

Namely, when determining that createCode( ) function is included in the lines read from the source file (YES in step S50), the code conversion section 14 refers to the error number table 31, and specifies the error number (step S55). Namely, the code conversion section 14 reads the first argument (error1 or error2 in FIG. 18) of the printErrorDialog function having createCode( ) function as the second argument.

Then, the “errorNumber” in the record where the first argument is registered in “errorName” in the error number table 31 is read. This becomes the error number. Further, similar to the procedure in FIG. 15, the code conversion section 14 specifies the version, the file code, and the line number of the program 20. By doing this, the error code of FIG. 17 may be generated.

The code conversion section 14 replaces the createCode( ) with the generated error code (step S70). After step S70, the process goes in the same manner as in Embodiment 1.

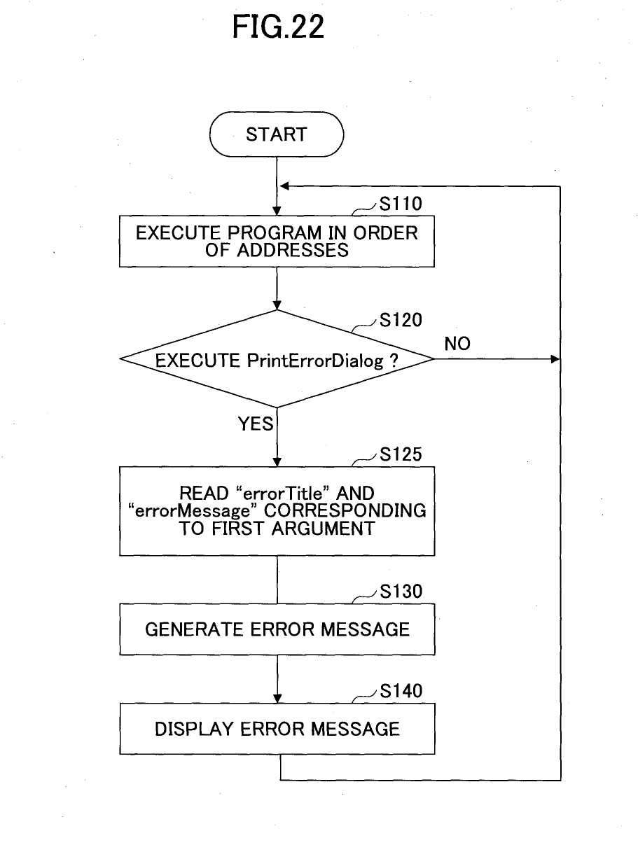

FIG. 22 shows an example of a flowchart illustrating a process of displaying the error message when the program execution apparatus executes the program 20.

The program execution apparatus executes the program 20 in the order of addresses without any call to a branch or a subroutine (step S110).

Then, it is determined whether an error in, for example, an if sentence is detected (step S120). When the error detection section 18 determines that an error is detected (YES in step S120), the error message display section 19 reads “errorTitle” and “errorMessage” in a record where the first argument of the PrintErrorDialog function is registered in “errorName” (step S125).

Next, the error message display section 19 generates the error message (step S130). Specifically, the character string such as “0001-051100B” as the second argument is read from the RAMs 203, 103, the HD 204, and the flash memory 104. This corresponds to Description 3. Further, by setting “errorTitle”, “errorMessage”, and the character string, as Descriptions 1, 2, and 3, respectively, the error message is generated. The positions of the Descriptions 1, 2, and 3 are designated as attributes of the PrintErrorDialog function when the developer generates the source file.

The error message display section 19 displays the error message on the displays 208, 120 and the like (step S140). By doing this, the error code including the error number is displayed as a part of the error message.

Therefore, the user may report the error code to the support center. Also, the user may check the error contents and resolving measures by referring to the manual or the Web page based on the error number. When the user pushes the OK button, the program execution apparatus resume a process from the instruction next to the PrinErrorDialog function.

As described above, according to the program execution apparatus and the program generation apparatus in this embodiment, in addition to the effect in Embodiment 1, it may become possible for the user to check the error contents and resolving measures.

### Embodiment 3

In this embodiment, the program execution apparatus reporting the error message to the support center is described.

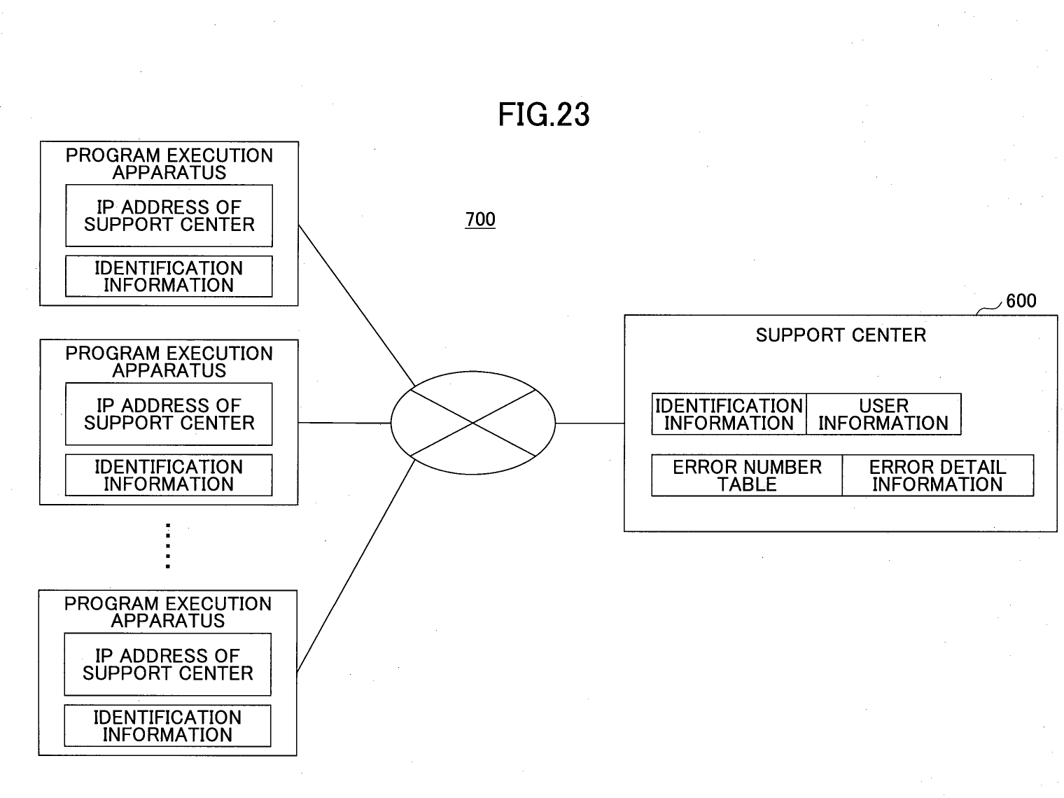

FIG. 23 shows an example of a configuration of an error report system 700. Plural program execution apparatuses are communicatively connected with a terminal 600 for maintenance in the support center via a network. Description of the hardware configuration of the terminal 600 for maintenance in the support center is similar to that of the information processing apparatus 100. Therefore, the repeated description is omitted.

In the program execution apparatuses, the IP address of the terminal 600 for maintenance in the support center is registered in advance. Instead of the IP address, the Uniform Resource Locator (URL) may be used to specify the terminal 600 for maintenance in the support center. Further, in the program execution apparatuses, the identification information is also registered in advance. The identification information uniquely specifies the program execution apparatuses, and includes a number(s), an letter(s), or a symbol(s) or any combination thereof.

Upon reporting the error message, the program execution apparatus transmits the identification information to the support center.

The terminal 600 for maintenance in the support center includes user information corresponding to the identification information. The user information may include a company name, a division name, an address, and contact information. The support center specifies the user of the program execution apparatus based on the identification information, and may provide an after service and the like.

Further, there may exist some users who are reluctant to provide the user information based on the identification information. Therefore, the user may set the program execution apparatus so that automatic transmission of the identification information from the program execution apparatus is prevented. Otherwise, the automatic transmission of the identification information may be permitted, but the user may ask the support center to prevent the registration of the user information.

Further, the terminal 600 for maintenance in the support center stores the error number table 31 and error detail information. The error number table 31 is similar to that in Embodiment 2. The error detail information may be more specific information than “errorTitle” and “errorMessage” in the error number table 31.

Since the terminal 600 for maintenance in the support center stores the error number table 31, the terminal 600 for maintenance in the support center may display the error message on the display of the terminal 600 based on the error number received from the program execution apparatus. Further, the terminal 600 for maintenance may display the error detail information on the display of the terminal 600 based on the error number received from the program execution apparatus. Further, the terminal 600 for maintenance may display the identification information of the program execution apparatus or the user information of the program execution apparatus.

Therefore, even though the user of the program execution apparatus does not report the error code to the support center, the support center may specify not only the error message but also the program execution apparatus (or the user) where the error occurs. Moreover, the support center may specify (pinpoint) the instruction of the program where the error occurs.

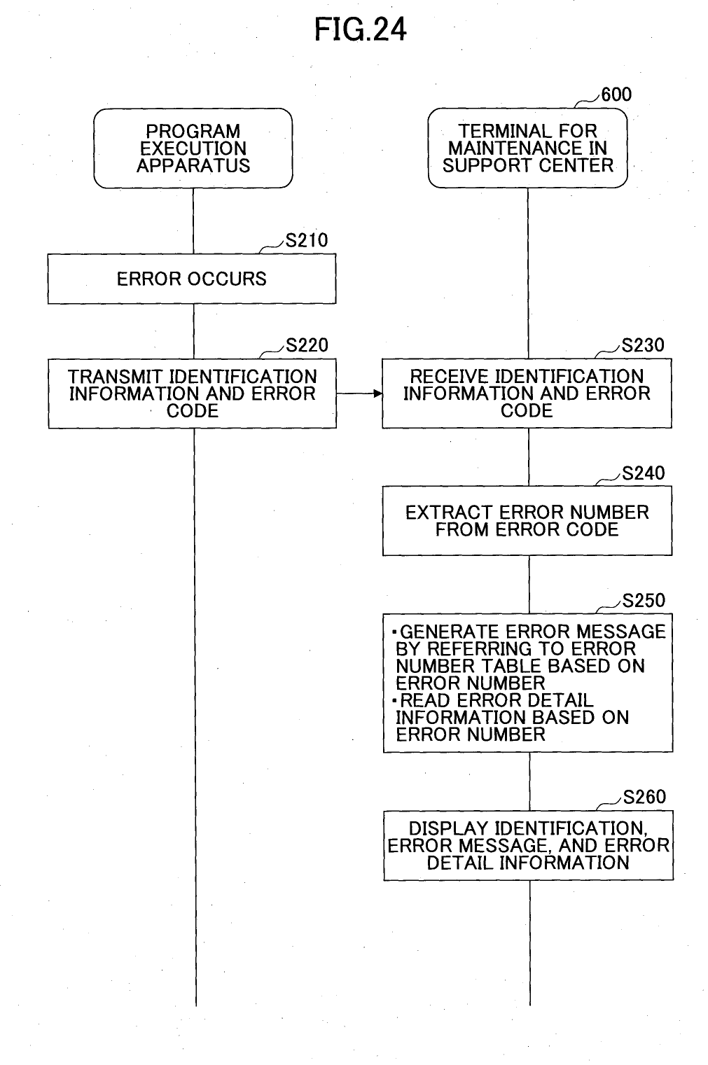

FIG. 24 shows an example of a flowchart illustrating operational processes of the program execution apparatus and the terminal 600 for maintenance in the support center.

While the program execution apparatus executes the program, an error occurs (step S210). As described in Embodiment 2, the program execution apparatus generates the error message. The program execution apparatus in this embodiment transmits the entire error message or at least the error code of the error message and the identification information to the terminal 600 for maintenance in the support center (step S220).

The terminal 600 for maintenance in the support center receives the identification information and the error code (step S230).

The terminal 600 for maintenance in the support center extracts the error number of the first to the fourth digits from the error code (step S240).

The terminal 600 for maintenance in the support center refers to the error number table 31 based on the error number, and generates the error message, or reads the error detail information based on the error number (step S250).

The terminal 600 for maintenance in the support center displays the identification information, the error message, and the error detail information on the display (step S260).

As described above, in the error report system 700 in this embodiment, the program execution apparatus transmits the identification information and the error code, and the terminal 600 for maintenance in the support center displays the identification information. By doing this, it may become possible to specify the program execution apparatus where an error occurs. Further, the error message is displayed. Therefore, it may become possible to specify (pinpoint) the instruction of the program where the error occurs. Further, the error detail information is displayed. Therefore, the support center may specify the error contents and know the resolving measures.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application Nos. 2011-157183 filed Jul. 15, 2011, and 2012-111680 filed May 15, 2012, the entire contents of which are hereby incorporated herein by reference.

1. An embedded apparatus displaying an error message upon detection of a failure during execution of a program, the embedded apparatus comprising:
a central processing unit configured to execute the program;
a program storage unit configured to store an executable compressed file where plural files are combined as the program;
a failure detection unit configured to detect a failure based on storage contents of addresses storing execution results of instructions; and
an error message display unit configured to output the error message on a display device when the failure detection unit detects the failure, the error message including version information of the program, file identification information of the file, and line numbers of the instruction being executed in the file, the error message being described in the instruction.

2. The embedded apparatus according to claim 1,
wherein the error message further includes error numbers for identifying error contents.

3. The embedded apparatus according to claim 1,
wherein the error message display unit is configured to read the version information described in the program, the file identification information, and the line numbers from predetermined addresses in a memory included in the embedded apparatus.

4. The embedded apparatus according to claim 3,
wherein the error message display unit is configured to read a first character string and a second character string from predetermined addresses of a memory included in the embedded apparatus, the first character string corresponding to a first argument of an instruction described in the program, the second character string corresponding to a second argument of an instruction described in the program.

5. The embedded apparatus according to claim 4,
wherein the first character string indicates that a failure occurs, and the second character string indicates a resolving means.

6. The embedded apparatus according to claim 3, further comprising:
an error table where a first character string and a second character string are associated and stored with a first argument of an instruction described in the program,
wherein the error message display unit is configured to read the first character string and the second character string corresponding to the first argument of the instruction in the error table, and arrange the first character string and the second character string at predetermined positions in the error message.

7. The embedded apparatus according to claim 6,
wherein the first character string indicates an error name, and the second character string indicates error contents.

8. The embedded apparatus according to claim 1, further comprising:
a program download unit configured to download the program from a connected server via a network.

9. The embedded apparatus according to claim 2, further comprising:
a transmission unit configured to transmit the error message and identification information to an information processing apparatus connected via a network, the error message including at least the error number, the identification information identifying the embedded apparatus.

10. A program generation apparatus generating an executable compressed file where plural files are combined, the program generation apparatus comprising:
a file storage unit configured to store file designation information designating the plural files and the file to be combined;
a version information acceptance unit configured to accept an input of version information of the program;
an identification table generation unit configured to generate a file identification table by adding file identification information to the plural files designated in the file designation information; and
a symbol replacement unit configured to replace predetermined symbols described in the file with the version information accepted by the version information acceptance unit, the file identification information of the file registered in the file identification table, and line number of lines or nearby lines where the symbols are described.

11. A non-transitory computer readable recording medium including a program causing an embedded apparatus, including a central processing unit executing the program and a program storage unit storing an executable compressed file where plural files are combined as the program and displaying an error message upon detection of a failure during execution of a program, to execute:
a failure detection step of detecting a failure based on storage contents of addresses storing execution results of instructions; and
an error message display step of outputting an error message on a display device when the failure detection step detects the failure, the error message including version information of the program, file identification information of the file, and line numbers of the instruction being executed in the file, the error message being described in the instruction.

12. (canceled)

13. The program generation apparatus according to claim 10,
wherein the version information of the program, the file identification information identifying the file, and the line numbers of instructions being executed in the file are described in the compressed file where the plural files are combined.
